(19) United States
(12) Patent Application Publication
(10) Pub. No.: US 2017/0177748 A1
(43) Pub. Date: Jun. 22, 2017

(54) Residential Upgrade Design Tool

(71) Applicant: Wal-Mart Stores, Inc., Bentonville, AR (US)

(72) Inventors: Donald High, Noel, MO (US); David Winkle, Bella Vista, AR (US); Michael Dean Atchley, Springsdale, AR (US)

(21) Appl. No.: 15/379,332

(22) Filed: Dec. 14, 2016

Related U.S. Application Data
(60) Provisional application No. 62/268,349, filed on Dec. 16, 2015.

(51) Int. Cl. G06F 17/50; G06T 17/05; G06T 7/40; G06K 9/00; H04N 1/00

(52) U.S. Cl. CPC G06F 17/5004; G06K 9/00637; H04N 1/00827; G06T 7/40; G06T 17/05; G06T 2207/10032; G06T 2207/30184; G06T 2210/04; G06F 2217/04

(57) ABSTRACT

A user inputs an address to a computer system, which retrieves an aerial image of the lot and identifies features visible in the image. A user selects a feature and a scanning drone is programmed with GPS coordinates of the boundary of the feature. The drone scans the feature and a model is generated. Upgrades for the feature are selected based on local weather and other factors. The model is updated according to a selected upgrade and rendered for a user. Training materials may be generated that include illustrations of the model modified to show intermediate stages of applying an upgrade. Materials required to apply the upgrade are determined from a surface area of the feature, including taking into account texture detected by scanning.

### CROSS-REFERENCE TO RELATED APPLICATIONS

This application claims the benefit of U.S. Provisional Patent Application 62/268,349 filed Dec. 16, 2015, and titled “Residential Upgrade Design Tool”, the entire contents of which are hereby incorporated herein by reference.

### BACKGROUND

Field of the Invention

This invention relates to systems and methods for specifying upgrades to a structure, such as an exterior of a home.

Background of the Invention

Many customers roam a paint center wondering what would look best with their current furniture, curtains, and carpet indoors. A customer may likewise look for exterior upgrades that work with the landscape of neighboring houses, such as the color of paint or texture to use. It is a common experience for a consumer to select a paint color, but subsequently be required to buy new furniture, curtains, or carpets to match the paint. Many people are not painters, and do not know how to proceed. Many do not know what to color to paint where.

The systems and methods disclosed herein provide an improved approach for making design choices when painting or performing other upgrades.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIG. 3 is a process flow diagram of a method for identifying features for upgrading in accordance with an embodiment of the present invention;

FIG. 4 is a schematic representation of an aerial image of a lot;

FIG. 5 is a process flow diagram of a method for obtaining feature measurements in accordance with an embodiment of the present invention;

FIGS. 6A and 6B are isometric views of the lot;

FIG. 7 is an isometric view of a textured surface;

FIG. 8 is a process flow diagram of a method for modeling and facilitating upgrades in accordance with an embodiment of the present invention;

FIG. 9 is a rear isometric view of an updated lot; and

FIG. 10 is an isometric view of an updated interior space.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

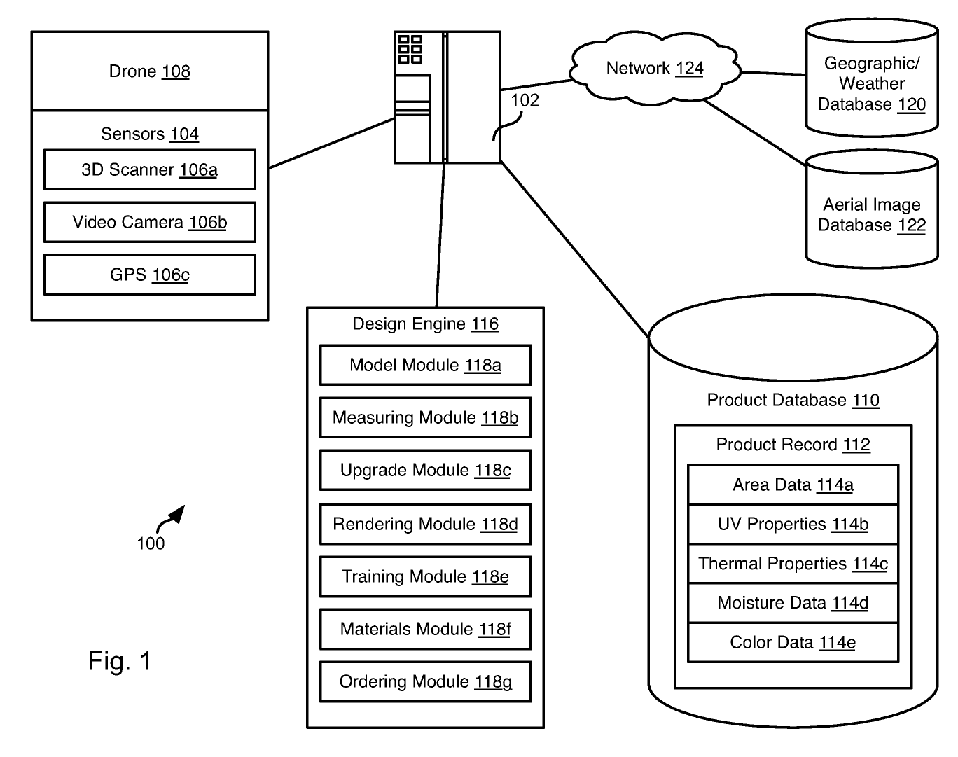

Referring to FIG. 1, a network environment 100 for implementing the systems and methods disclosed herein may include some or all of the illustrated components. As described in greater detail herein, the environment 100 may be used to facilitate the making of design choices and to enable the visualization of design choices in an interior or exterior space. To that end, a server system 102 may receive data from one or more sensors 104.

The sensors 104 may include one or more three-dimensional (3D) scanners 106a. The 3D scanners 106a may include any three-dimensional scanner known in the art. For example, the 3D scanners 106a may include the FARO FOCUS 3D laser scanner or other type of laser scanner. The 3D scanners 106a may include an optical scanner such as the FARO FREESTYLE3D SCANNER or some other optical 3D scanner known in the art. In some embodiments, the 3D scanner 106a may be mounted to an unmanned aerial vehicle (e.g. quad copter or other drone) that is programmed to fly with the scanner around an interior or exterior space in order to perform a scan. In some embodiments, rather than performing scanning, 3D data of a lower quality may be inferred from 2D images or video data.

The sensors 104 may include a video camera 106b. In some embodiments, a field of view of the 3D scanner 106a may be simultaneously captured with the video camera 106b during scanning. The image data from the video camera may then be overlaid on a point cloud obtained from the 3D scanner 106a to obtain a full color model of the area scanned. The manner in which the point cloud and image data are combined may include any technique known in the art.

The sensors 104 may be mounted to a flying drone 108 or other apparatus that is programmable to survey a particular area. For example, the drone 108 may be a remotely controlled quadcopter or other type of unmanned aerial vehicle (UAV) known in the art. Accordingly, the sensors 104 may include a GPS (Global Positioning System) receiver 106c such that the drone 108 may determine its location relative to a desired path.

The server system 102 may select products and treatments from a product database 110 as potential design elements for a space scanned using the sensors 104. The product database 110 may include a plurality of product records 112 for a plurality of products or treatments available from one or more retailers. The product record 112 may correspond to paint, stucco, siding, wall paper, curtains, base board trim, molding, crown molding, doors, windows, decking material (e.g. lumber or synthetic decking material), concrete, etc. that may be used to upgrade or maintain an interior or exterior area.

Accordingly, the product record 112 may include one or more data fields used to determine suitability of the product corresponding thereto to a particular application. For example, the product record 112 may include area data 114a indicating how large of an area may be treated (painted, covered in stucco, covered in decking etc.) by a unit of the product. In some instances, a product may be cut to a custom size (e.g. curtains). Accordingly, the area data 114a for such a product may indicate a maximum or minimum size to which that product may be cut.

The product record 112 for a product may further include properties of the product and its ability to handle environmental conditions. For example, ultraviolet (UV) properties 114b may indicate the ability of the product to withstand (or vulnerability to) UV light. For example, a product may be suitable for exterior use in full sun or may be suitable for interior use in full sun. Another product may not be suitable for interior or interior exposure to UV light. Accordingly, the product record 112 may note this information in the UV properties 114b.

The product record 112 may include thermal properties 114c that indicate a range of temperatures for which the product is suitable. For example, an exterior paint may be suitable for a both winter and summer temperatures whereas an interior paint is only suitable for use for interior temperatures (e.g. 50 to 80 degrees Fahrenheit).

The product record 112 may include moisture data 114d indicating suitability for exposure to moisture. For example, an interior paint may be approved only for exposure to moisture only during washing. An exterior paint may be approved for exposure to rain and snow. Another exterior paint may be approved for constantly humid conditions (e.g. have mold resistant properties).

The product record 112 may include color data 114e and/or other style data. In particular, the color of the product, a style of the product, the finish of the product (matte, shiny, etc.) may be recorded in the data 114e.

The server system 102 may host or access a design engine 116. The design engine 116 may include a model module 118a. The model module 118a may generate a model from a point cloud from the 3D scanner 106a and image data from the camera 106b. The model module 118a may combine these to define a full color model of a room that has been scanned. The model module 118a may perform a filtering function, i.e. cleaning up of a model to remove extraneous data points resulting from the scanning.

The design engine 116 may include a measuring module 118b programmed to identify features and surfaces from the model generated by the model module 118a and determine the dimensions (e.g. height and width) thereof. Walls may be identified as vertical planar surfaces. Windows may be identified based on their geometry: a vertical planar surface that is offset horizontally from a surrounding planar surface. Doors may be identified in a similar manner: a rectangular gap in a vertical planar surface. Counters and tables may be identified as horizontal planar surfaces vertically offset above a horizontal planar surface representing a floor. A deck may be identified as a horizontal surface adjacent a vertical surface protruding from a vertical surface corresponding to a wall. Features may also be identified manually. For example, a user may select a feature and specify what it is (window, wall, deck, etc.).

The design engine 116 may include an upgrade module 118c that identifies potential upgrades for features identified by the measuring module 118b. For example, for a feature identified as a wall, the upgrade module 118c may select window treatments (curtains, valances, blinds, molding) that may be placed over or around the window. For a feature identified as an interior wall, paints rated for interior use may be selected. For an exterior wall, paints, siding, stucco, or other treatments rated for exterior use may be selected. In some embodiments, the upgrade module 118c may retrieve weather information, such as from a database 120. For example, the server system 102 may be coupled to the database 120 storing historical weather data by geographic region. Accordingly, for a location of a structure being processed, the weather data may be retrieved. Where the feature to be upgraded is exterior, then paint, decking, stucco, or other products may be selected that are suitable for the weather extremes for that location according to the data from the database. Likewise, where the weather data and orientation of a feature indicates high humidity and/or low exposure to sunlight, then products that are resistant to mold may be selected. For example, the orientation of the feature may be determined from the location of the feature in an image of the structure retrieved from an aerial image database 122, such as images taken from a satellite, aircraft, or drone.

The databases 120-122 may be accessed by the server system 102 over a network 124 such as a local area network (LAN), wide area network (WAN), the Internet, or other type of network.

The upgrade module 118c may select potential upgrades and present them to a user. The user may then specify which of the potential upgrades to visualize by a rendering module 118d. The rendering module 118d may apply an upgrade to the model and render the upgraded model on a display device. For example, where the feature is a window in an interior space, then a model of blinds may be added over the window in the model of the interior space. Where the feature is an interior or exterior wall, then the model of that wall may be colored or textured according to the upgrade. Where the upgrade is a deck, a model of the deck may be added adjacent to a model of the structure next to which it is to be placed.

A training module 118e may select training media for installing or applying upgrades selected by the upgrade module 118c. For example, the training media may retrieve pre-recorded training videos or documents for a particular upgrade. In some embodiments, virtual application or installation of an upgrade may be modeled using the model generated by the model module 118a. For example, where a deck is to be built, a presentation may include animated process of placing the components of the deck in proper positions relative to the model of the portion of the structure along which it is to be built.

The design engine 116 may include a materials module 118f. The materials module 118f may use area data 114a from the product used to perform an upgrade and an area of the feature to be upgraded as determined by the measuring module 118b to determine an amount of the product required. Likewise, other materials or tools may be selected for installing or applying the upgrade. Where the other materials or tools are consumed, a quantity required may be determined from the area data 114a for the tool and the measurements of the feature to be upgraded. An ordering module 118g may then invoke ordering and shipment of the materials identified by the materials module 118f in response to a user instruction to do so.

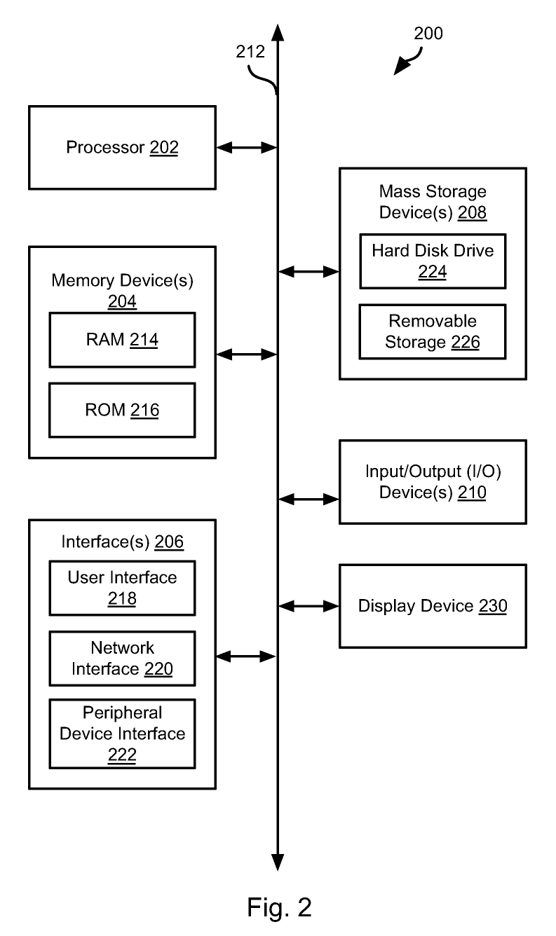

FIG. 2 is a block diagram illustrating an example computing device 200. Computing device 200 may be used to perform various procedures, such as those discussed herein. The server system 102 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102 may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

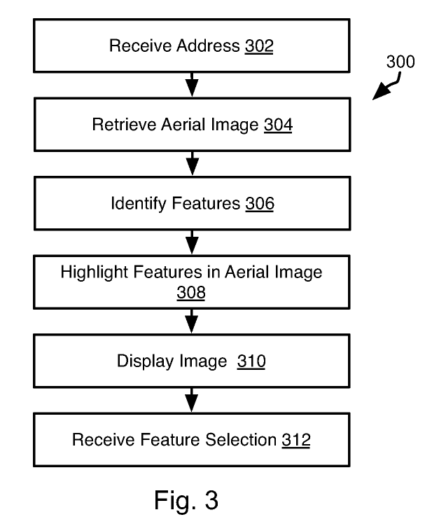

Referring to FIG. 3, the illustrated method 300 may be executed by a server system 102 in combination with an aerial image database 122 in order to identify features to be three-dimensionally scanned. Alternatively, the method 300 may be performed on a desktop or tablet computer located at a retail store or a user's home.

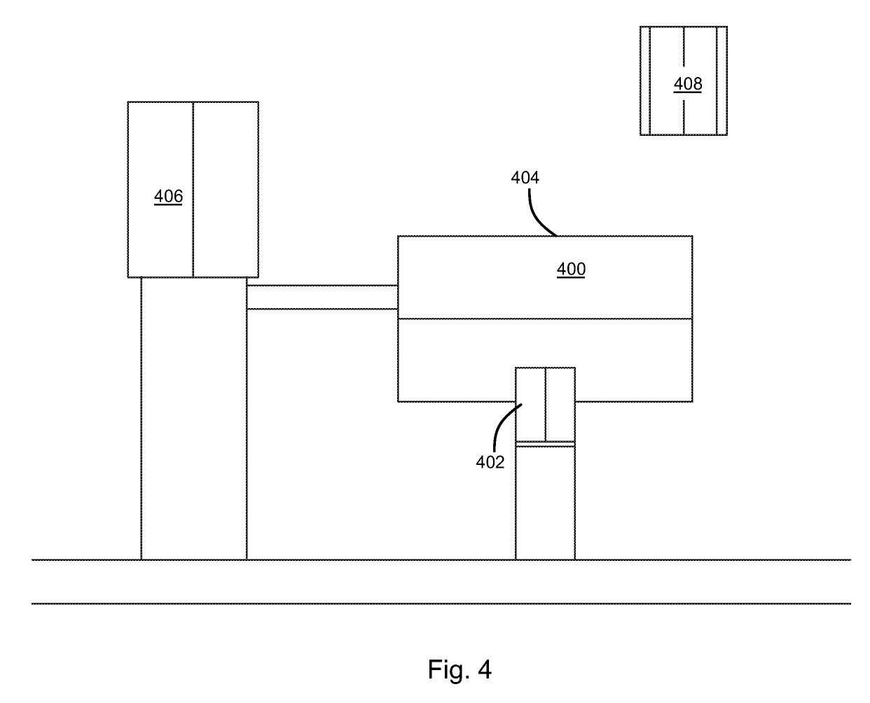

The method 300 may include receiving 302 an address and retrieving 304 an aerial image of a lot located at that address, such as from the aerial image database 122. The method 300 may further include identifying 306 features. For example, FIG. 4 schematically illustrates an aerial image of a lot. The image may then be analyzed to identify a feature such as a home 400 and/or features of the home 400, such front porch 402, rear wall 404, and the like. Other features and outbuildings may be identified such as an attached or detached garage 406, shed 408, trees, gardens, walkways, driveways, and the like. Features may be identified by contrast to surrounding areas, e.g. the color of a roof of the house 400 may be used to distinguish it from surrounding grass, concrete, shrubbery, etc. The manner by which separate features are identified may include any image analysis techniques known in the art. In particular, what a feature actually is may not be determined in some embodiments, but rather that it is visually distinguishable from its surroundings or other features.

Turning again to FIG. 3, the features identified at step 306 may be highlighted in the aerial image, for example, a line in a highly visible color may be placed around each identified feature or features may be highlighted with differing colors to indicate that they have been identified as potential features.

The image as highlighted at step 308 may then be displayed 310 to the user and the selection of a feature or portion of a feature may be received 312. In some embodiments, a user may manually select or trace the outline of a feature that was not identified at step 306 or select a portion of a feature that was identified at step 306 using a touchscreen, mouse, or other input device.

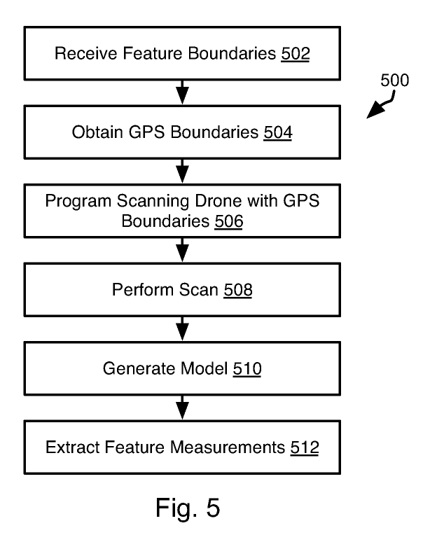

Referring to FIG. 5, the features automatically identified and then selected may be processed by the server system 102 according to the illustrated method 500. The method 500 may include receiving 502 feature boundaries of a selected feature from the aerial image as determined according to the method 300. In particular, the boundary used to identify the feature as being a visually distinct feature in an image may be identified at step 502. The corresponding GPS coordinates of the feature boundary may then be obtained 504. For example, a point, e.g. a corner, of an aerial image may have GPS coordinate associated with it in the aerial image database 122. Alternatively, multiple corners may have GPS coordinates associated therewith in the aerial image database 122 enabling both the location and the orientation to be determined. The aerial image may have a scale associated therewith that matches pixels to distance. Alternatively, where multiple locations in the aerial image are mapped to GPS coordinates (e.g. corners) then the distance between those locations in pixels may be used to map a distance to pixels.

Accordingly, locations along the boundary of the feature may then be mapped to GPS coordinates according to a known coordinate for one or more points in the image plus an offset in pixels to the locations along the boundary multiplied by the scale of the image.

The method 500 may then include programming 506 a scanning drone 108 or other device with the GPS coordinates of the boundary of the feature to be scanned. Alternatively, the coordinates could be provided to a human operator of the sensors 104, who may then scan the feature within the boundaries using the sensors 104.

The method 500 may then include performing 508 the scan using the drone 108, which will then fly along the boundary, e.g. at some offset therefrom, and scan the feature. Where the feature has significant height, the drone 108 may perform multiple passes along the boundary at different altitudes in order to scan the entire height of the feature as well as its horizontal extent as define by the boundary. The drone 108 may determine the height of the feature automatically or may receive a human-defined instruction indicating the height of the feature.

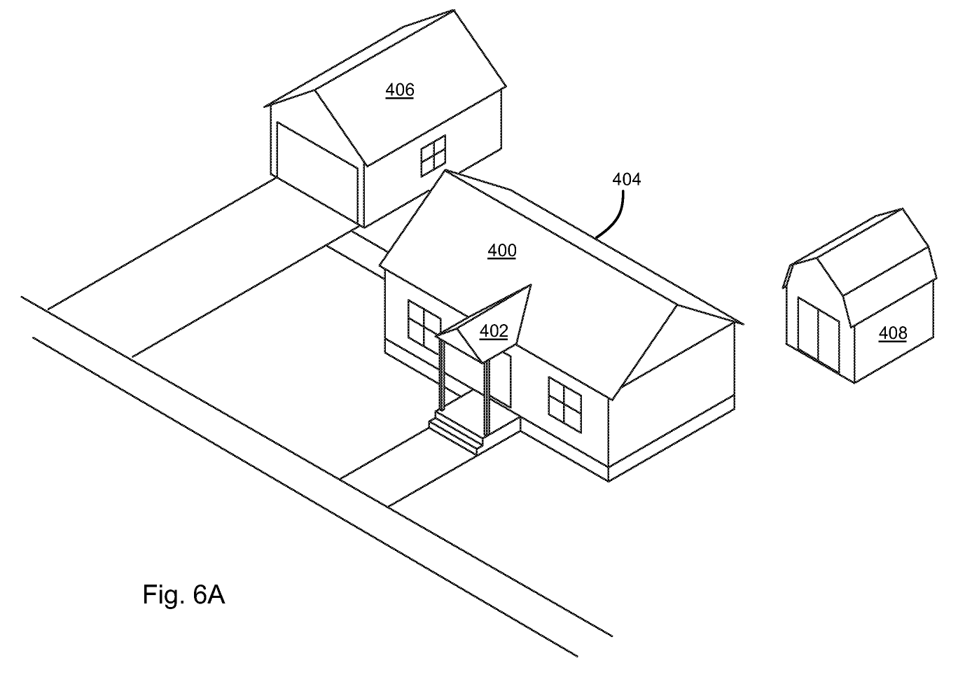

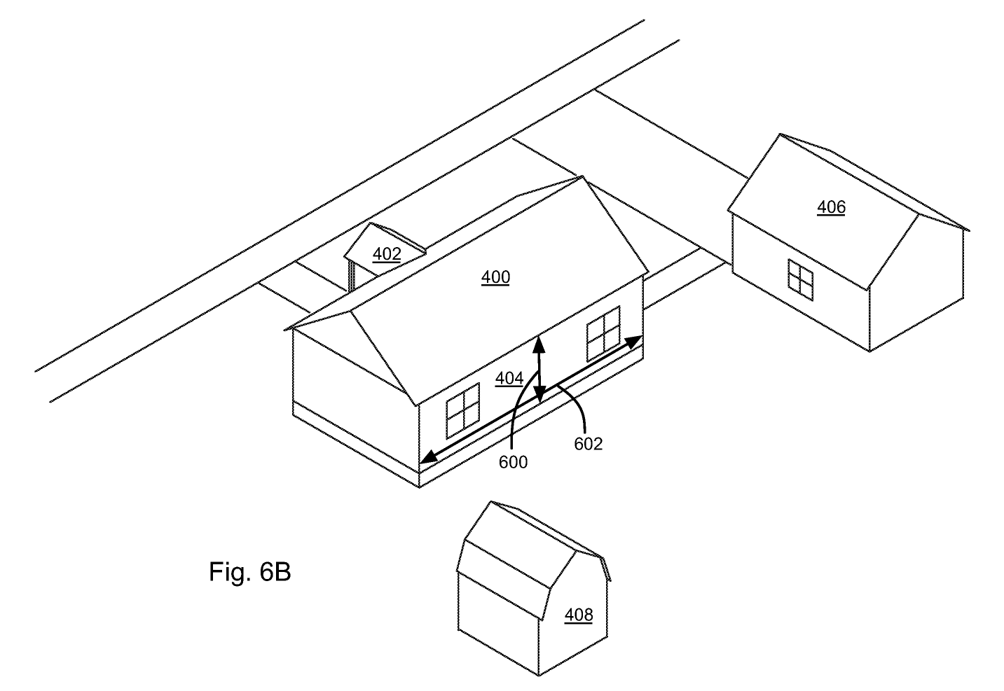

The method 500 may include generating 510 a three-dimensional model of the feature scanned at step 508. For example, a result of the scan of step 508 may be a point cloud. A model may be defined as a set of triangles each having as one of its vertices a point in the point cloud. For example, FIGS. 6A and 6B illustrate models of the features apparent in the aerial image of FIG. 4. As noted above, a single feature may be selected. Accordingly, in some instances only one of the house 400, garage 406, and shed 408 may be scanned and a model thereof generated. Likewise, in some instances, only a portion of the house 400, garage 406, and shed 408 is scanned and a model thereof generated. For example, just the back wall 404 or the porch 402.

In some embodiments, the three-dimensional model may be generated from a two-dimensional (2D) data, such as images or video data rather than a point cloud obtained from a 3D scanner 106a. For example, the user may provide a 2D image or video of an interior or exterior space that is uploaded to the server system which processes it to obtain a 3D model of the interior or exterior space.

Where the model of step 510 is of an exterior space, the model may include environmental features such as trees and landscaping in addition to the feature (e.g. house or outbuilding) to be upgraded. Accordingly, these features may be retained as part of the model in order to facilitate visualization of upgrades in context. The model of step 510 may be stored for subsequent upgrades in addition to an initial upgrade that prompted generation of the model.

The method 500 may then include extracting 512 measurements of the feature. For example, where a feature is an exterior wall, points in the model lying in a vertical plane may be identified and the extent occupied by points in the vertical plane may then be measure, e.g. the height 600 and width 602 of the back wall 404. A floor or ceiling may likewise be identified as points lying along a horizontal plane. Where the feature is a window, then the extent of the window may be identified in a similar fashion. For example, a window may be identified as a vertical surface horizontally offset from a surrounding vertical surface corresponding to a wall. Crown molding may be identified as being located at the intersection between a horizontal surface corresponding to a ceiling and a vertical surface corresponding to a wall. The length of the intersection may be determined to be the length of the crown molding.

The dimensions of the features may be output as a height and a width, a length, or as a set of measurements of facets of a feature, e.g. different walls of a shed or house, each including a height and width for vertical surfaces or a width and depth for horizontal surfaces.

In addition to extracting measurements, the method 500 may include extracting other information from the model, such as a style of house, kinds of trees nearby, a style of neighboring houses, the presence/style of an adjacent garden, etc.

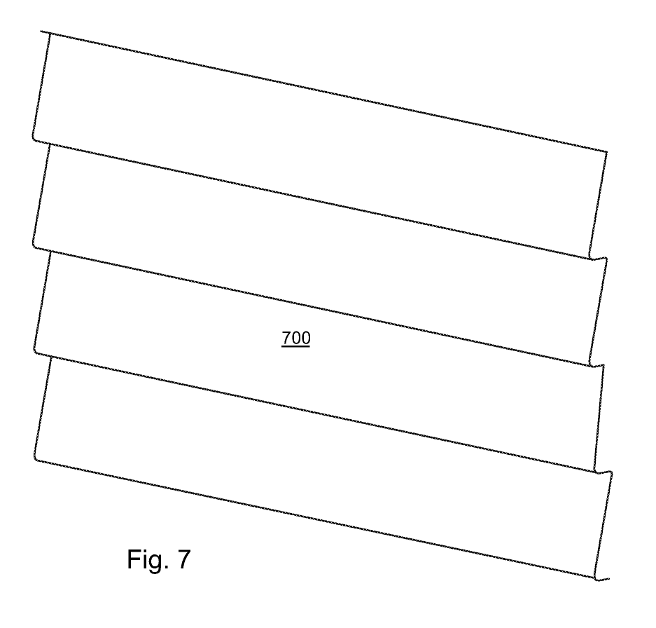

Referring to FIG. 7, in some embodiments, extracting 512 measurements may include extracting a surface area of a surface, i.e. a measurement of the surface area that takes into account a texture of the surface in addition to the horizontal and vertical extent thereof. For example, the illustrated section of siding 700 has peaks and valleys such that the area that would need to be covered with paint will be greater than the width multiplied by the height of the siding 700. Other finishes such as brick, shingles, stucco, and the like may also have a surface area that is greater than the width times height area of the surface.

Accordingly, inasmuch as the three-dimensional measurements of the surface provides a point cloud, textural data may be extracted. For example, a model may include a series of triangles connecting points of a point cloud obtained from scanning. Accordingly, for a wall, the areas of the triangles within the vertical and horizontal extent of the wall may be summed to obtain an estimate of the paintable surface area of the wall. Alternatively, to reduce computation, the areas of triangles of a small section of the wall having a known horizontal and vertical extent may be summed to obtain a scaling factor K, K=(sum of triangle areas)/(width×height). The extent of the total wall (width×height) may then be multiplied by K to obtain an estimate of the paintable area of the wall. The paintable area of ceilings of other structures may be measured in a like manner.

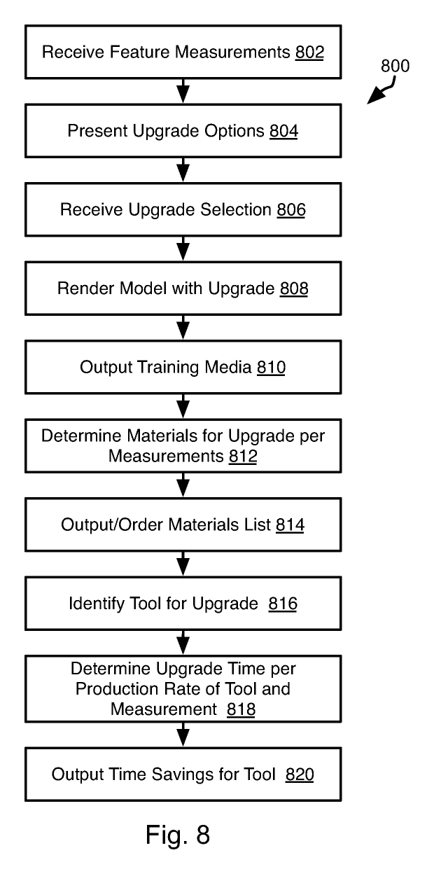

Referring to FIG. 8, the illustrated method 800 may be executed by the server system 102 to select, visualize, and install or apply upgrades to a feature identified and measured according to the foregoing methods. The method 800 may include receiving 802 feature measurements obtain from step 512 of the method 500 and presenting 804 upgrade options for the feature measured. Where the feature is a window, upgrade options may include curtains, blinds, valances, etc. that may be added over or around a window. Where the feature is an interior wall, interior paints, wall papers, moldings, etc. may be presented at step 804. Where the feature is an exterior wall, exterior treatments such as exterior paint, stucco, brick or rock veneers, and the like may be proposed. Likewise, exterior features such as decks, pools, raised gardens, etc. may be presented for an exterior wall or other exterior feature.

Presenting 804 upgrade options may include presenting options including supplies for a particular need of the customer based on, for example, the geographic location, weather, and orientation of the feature to be upgraded. For example, the best type of paint for a previously-unpainted surface may be selected or a paint for re-painting an existing surface may be selected based on whether the model indicates a painted or unpainted surface. Likewise, an exterior paint or deck sealer may be presented at step 804 that is suited for the sun and moisture exposure of the exterior wall to be painted or the expected location of the deck based on the geography specific weather data.

Presenting 804 upgrade options may include presenting options meeting user-provided preferences or attributes of the user. For example, a user may specify a color palette and upgrade options may be selected as being included in the color palette. Likewise a user may specific a style and upgrades may be selected that are identified in product records as corresponding to the specified style. A user may indicate that they have children or pets and the upgrades may be presented having product records indicating compatibility with the presence of children or pets.

The method 800 may further include receiving 806 an upgrade selection from among the options presented at step 804. The presenting 804 of options may include transmitting an interface including the options to a user computer and receiving 806 a selection may include receiving a selection from the user computer.

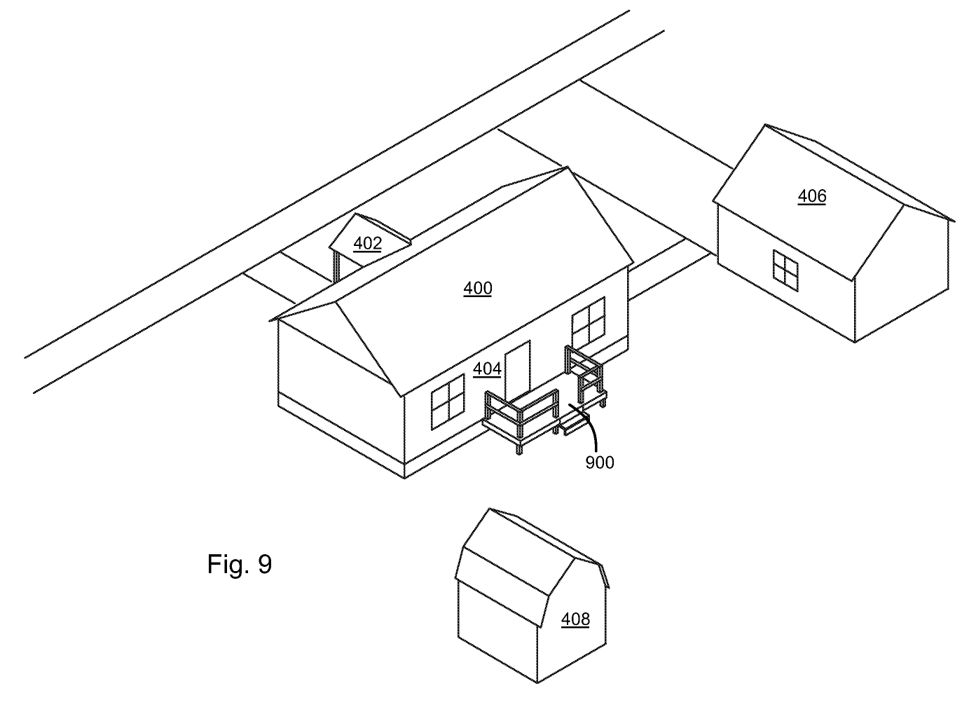

The method 800 may include rendering 808 the model of the feature with the selected upgrade applied thereto. For example, referring to FIG. 9, where the feature is the back wall 404, or all the exterior walls, of the house 400, a model of the house 400 may be rendered having the walls colored or textured according to the selected upgrade. Where the upgrade is a color of paint, then the walls may be changed to the color of the paint. Where the upgrade is siding, then siding of a selected color may be modeled on the side of the model of the house. In the illustrated embodiment, the upgrade may include a deck 900. Accordingly, a model of the deck 900 may be added adjacent the house 400 or at another location on the lot. The model of the deck may be pre-defined and may be scaled to a desired size and then added to the model of the house.

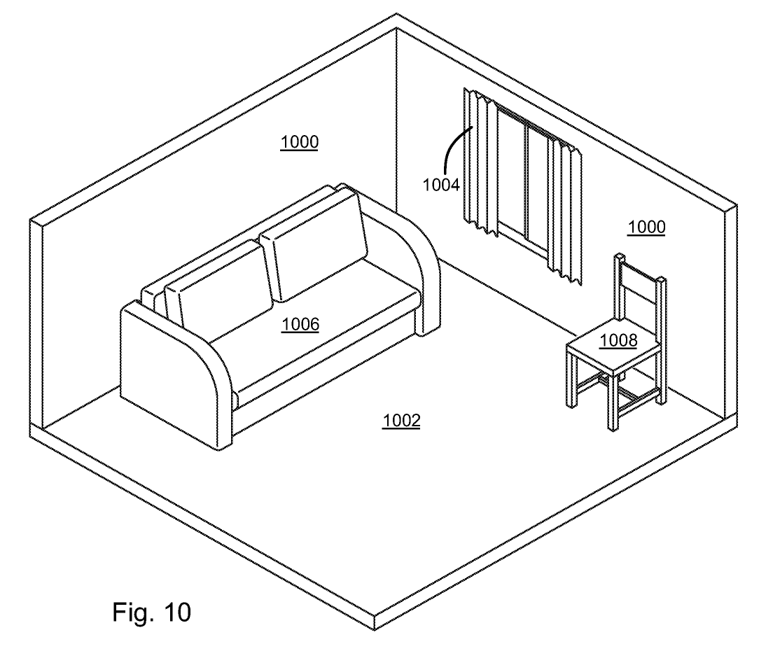

In another example, where the feature is an interior feature, a model of the room to be upgraded as shown in FIG. 10. Walls 1000 of the model may be modified to have the color of a selected paint or pattern of a selected wallpaper. The floor 1002 of the model may be modified to show a new carpet or other floor covering. Models of window treatments 1004 may be placed over windows in the model. Where the upgrade is furniture, models of the furniture 1006, 1008 may be placed in the model of the room. In some embodiments, rendering 808 the model with the upgrade may include three-dimensionally printing the upgraded model, including any texturing provided by the upgrade. The texture may be scaled larger than the scale of the printed model to accommodate limits of the resolution of the three-dimensional printing process

The method 800 may include outputting 810 training media. For example, where the upgrade is paint, stucco, or other liquid, the training media may include illustrations, text, video, or other content instructing how to apply the upgrade. Where the upgrade is installed, such as a deck, window treatments, or other structures, the media may instruct how to install the upgrade. In some embodiments, computer simulations of performing the upgrade may be generated based on the model of the feature. For example, where the upgrade is a deck 900 for the house 400, a computer generated video may be generated that includes images of the back wall 404 and shows each piece of the deck being placed and fastened in its proper place in the proper order with respect to the existing structures of the house 400.

In some embodiments, outputting 810 training media may include outputting renderings of the model of the feature with the upgrade shown at various stages of completion. For example, where the upgrade is paint, simulated 3D images of the model may be generated that show what the feature or features will look like at various stages of the project based upon predictive assumptions over time. Likewise, where the upgrade is painting, the training media may walk the painter through each step of the process, including taping, scraping, covering the floor and furniture, removing outlet covers and trim. Outputting 810 training media may further include displaying images showing what a surface should look like with a primer/sealer applied. The training media displayed at step 810 may show the user what a surface will/should look like with different texturing. The training media may include different videos illustrating how to perform these different stages of painting. Where the upgrade is sealing a deck, the training media of step 810 may show all the steps for preparing a deck for stain and sealer, for example.

The method 800 may further include determining 812 the materials for an upgrade based on measurements of the feature received at step 802. For example, where the upgrade is paint, stucco, or other liquid, the amount needed may be determined by multiplying the amount of the liquid required to be used per unit area by the area of the feature, which may include the area determined based on texture as well as extent of the feature as discussed above. An amount of other consumables that are used up in proportion to area to apply an upgrade may also be calculated based on the measured area. Where the upgrade is installed, then the parts required to perform the installation and the amount thereof may be determined based on the configuration of the upgrade and the area to be covered. For example, where the upgrade is a deck, then an amount of fasteners, posts, and decking boards required to cover the size of the deck may be determined based on pre-defined relationships between the amount of each of these items and the area of a deck.

The method 800 may further include outputting a materials list to a user computer and/or invoking automated ordering 814 of the materials determined at step 812. For example, the server system 102 may provide an easy way for products to be ordered, and shipped to the user's home, or picked up at a store. In some embodiments, the server system 102 may remind customers that they need certain products to complete the job and keep their work looking good (e.g., special cleaners, new curtains, blinds, other tools, etc.).

In some embodiments, an upgrade may be performed using either manual or power tools. Accordingly, a power tool that may be used to perform the upgrade may be identified 816. For example, a product record for the tool may record products with which it may be used or the product record of a material used (e.g. paint, decking) may record a power tool that may be used to apply it. In either case, the tool may be determined 816 for the upgrade selected at step 806. The tool or product record may further record an estimated product rate for the tool, e.g. unit area per unit time, that may be processed by the tool. Accordingly, a time required to perform the upgrade may be determined 818 by multiplying the production rate of the tool by the area to be upgraded, e.g. the area received at step 802. The method 800 may then include outputting 820 for display on a user computer a time savings that can be expected from use of the tool. In particular, the manual production rate (M) per unit area for an upgrade may be pre-determined and stored. The time savings may therefore be estimated as (M−T)×A, where T is the production rate of the tool and A is the area of the feature to be upgraded. In some embodiments, recommendations for contractors that perform the upgrade may also be output to the user.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method comprising:
receiving, by a computer system, an address;
retrieving, by the computer system, an aerial image of a lot corresponding to the address;
identifying, by the computer system, in the aerial image, at least one selected feature on the lot;
determining, by the computer system, geographical bounds of the at least one selected feature from the aerial image;
transmitting, by the computer system, the geographical bounds to a remote scanning system;
scanning, by the scanning system, within the geographical bounds at the lot to obtain a model of the at least one selected feature; and
identifying, by the scanning system, at least one upgrade to the at least one selected feature and a quantity of materials for the at least one selected feature from the model of the at least one selected feature.

2. The method of claim 1, wherein the at least one upgrade is a deck and the quantity is a quantity of decking materials for the deck.

3. The method of claim 1, wherein the at least one upgrade is paint for a surface of the at least one selected feature and the quantity is a quantity of the paint sufficient to cover the surface of the at least one selected feature.

4. The method of claim 3, further comprising determining the quantity by:
determining a texture of the surface from the model; and
estimating the quantity of the paint based on both an extent of the surface and the texture of the surface.

5. The method of claim 1, further comprising:
adding, by the computer system, a representation of the upgrade to the model to obtain an upgraded model; and
invoking, by the computer system, three-dimensional printing of the upgraded model.

6. The method of claim 1, wherein identifying, by the computer system, in the aerial image, at least one selected feature on the lot comprises:
identifying, by the computer system, a plurality of candidate features in the aerial image of the lot;
output, by the computer system, an image of the lot having the candidate features artificially distinguished from one another; and
receiving, by the computer system, a user selection of one of the candidate features as the at least one selected feature.

7. The method of claim 1, further comprising:
retrieving, by the computer system, weather information for the address; and
selecting, by the computer system, the at least one upgrade as being suitable for weather conditions indicated by the weather information.

8. The method of claim 7, further comprising:
determining, by the computer system, a geographic orientation of the at least one selected feature from the aerial image of the lot;
determining, by the computer system, sun exposure of the at least one selected feature from the weather information and the geographic orientation and location of the at least one selected feature; and
selecting, by the computer system, the at least one upgrade as suitable for a level of ultraviolet light exposure corresponding to the sun exposure of the at least one selected feature.

9. The method of claim 1, further comprising:
identifying, by the computer system, at least one power tool suitable for performing the at least one upgrade;
retrieving, by the computer system, a production rate for the at least one power tool;
determining, by the computer system, a time savings for performing the at least one upgrade using the at least one power tool based on the production rate; and
outputting, by the computer system, the time savings.

10. The method of claim 1, wherein the at least one selected feature is at least one of an exterior wall, outbuilding, and area of a yard.

11. A system comprising:
a three-dimensional scanning system;
a computer system comprising one or more processing devices and one or more memory devices operably coupled to the one or more processing devices, the one or more memory devices storing executable code effective to cause the one or more processors to:
receive an address;
retrieve an aerial image of a lot corresponding to the address;
identify in the aerial image, at least one selected feature on the lot;
determine geographical bounds of the at least one selected feature from the aerial image;
transmit the geographical bounds to a remote scanning system;
instruct the three-dimensional scanning system to scan within the geographical bounds at the lot to obtain a model of the at least one selected feature; and
identify at least one upgrade to the at least one selected feature and a quantity of materials for the at least one selected feature from the model of the at least one selected feature.

12. The system of claim 11, wherein the at least one upgrade is a deck and the quantity is a quantity of decking materials for the deck.

13. The system of claim 11, wherein the at least one upgrade is paint for a surface of the at least one selected feature and the quantity is a quantity of the paint sufficient to cover the surface of the at least one selected feature.

14. The system of claim 13, wherein the executable code is further effective to cause the one or more processors to:
determine a texture of the surface from the model; and
estimate the quantity of the paint based on both an extent of the surface and the texture of the surface.

15. The system of claim 11, wherein the executable code is further effective to cause the one or more processors to:
add a representation of the upgrade to the model to obtain an upgraded model; and
invoke three-dimensional printing of the upgraded model.

16. The system of claim 11, wherein the executable code is further effective to cause the one or more processors to identify in the aerial image, at least one selected feature on the lot comprises:
identifying, by the computer system, a plurality of candidate features in the aerial image of the lot;
output, by the computer system, an image of the lot having the candidate features artificially distinguished from one another; and
receiving, by the computer system, a user selection of one of the candidate features as the at least one selected feature.

17. The system of claim 11 wherein the executable code is further effective to cause the one or more processors to:
retrieve weather information for the address; and
select the at least one upgrade as being suitable for weather conditions indicated by the weather information.

18. The system of claim 17, wherein the executable code is further effective to cause the one or more processors to:
determine a geographic orientation of the at least one selected feature from the aerial image of the lot;
determine sun exposure of the at least one selected feature from the weather information and the geographic orientation and location of the at least one selected feature; and
select the at least one upgrade as suitable for a level of ultraviolet light exposure corresponding to the sun exposure of the at least one selected feature.

19. The system of claim 11, wherein the executable code is further effective to cause the one or more processors to:
identify at least one power tool suitable for performing the at least one upgrade;
retrieve a production rate for the at least one power tool; and
determine a time savings for performing the at least one upgrade using the at least one power tool based on the production rate;
output the time savings.

20. The system of claim 11, wherein the at least one selected feature is at least one of an exterior wall, outbuilding, and area of a yard.
